(19) United States
(12) Patent Application Publication
(10) Pub. No.: US 2006/0275741 A1
(43) Pub. Date: Dec. 7, 2006

(54) SPINE SIMULATOR SYSTEM

(75) Inventors: Samuel J. Chewning, Statesville, NC (US); Adam LaWare, Foxboro, MA (US)

Correspondence Address: NUTTER MCCLENNEN & FISH LLP, WORLD TRADE CENTER WEST, 155 SEAPORT BOULEVARD, BOSTON, MA, 02210-2604, US

(73) Assignee: DEPUY SPINE, INC., Raynham, MA (US)

(21) Appl. No.: 10/908,969

(22) Filed: Jun. 2, 2005

(51) Int. Cl. G09B 23/28

(52) U.S. Cl. 434/267

(57) ABSTRACT

Various exemplary simulator systems are provided for use in simulating surgical procedures. The exemplary simulator systems can be adapted to simulate spinal surgery procedures involving, for example, an anterior approach, a posterior approach, or a minimally invasive approach. The simulator is generally in the form of a box that serves a representation of a body cavity.

### BACKGROUND

Surgical simulation devices are helpful for training and educating a myriad of medical professionals. For example, it is beneficial for surgeons and students to be exposed to simulated surgical environments and anatomical structures when developing, learning or refining a surgical technique. Moreover, it is often advantageous for a manufacturer of surgical equipment to have the ability to conveniently demonstrate the use of new devices or techniques in a simulated surgical procedure.

At present, most surgical devices or procedures are practiced or demonstrated on cadavers. While effective, cadavers are expensive and can be difficult to obtain. Moreover, it can be hard to visualize a given procedure or the use of a particular surgical device during a cadaver demonstration.

Accordingly, there exists a need for an improved surgical simulation device, and in particular for a surgical simulation device for use in simulating spinal surgeries.

### BRIEF SUMMARY

Disclosed herein are various exemplary simulator systems for use in simulating surgical procedures. The exemplary simulator systems can be adapted to simulate spinal surgery procedures involving, for example, an anterior approach, a posterior approach, or a minimally invasive approach. The simulator system is generally in the form of a box that serves as a representation of a body cavity. The box is formed of and includes a variety of modular components, enabling the system to be assembled, disassembled, cleaned, and transported with relative ease. In one exemplary embodiment, at least a portion of the box is transparent.

In one aspect, a surgical simulator system is disclosed having a housing with a base and sidewalls. A plurality of strut members are adapted to be removably disposed on a support and spaced apart from each other. Each strut member can have a bottom surface matable with the support and a top surface having a specimen receiving notch formed therein, which can be adapted for receiving a surgical sample (e.g., a part of a spine). The surgical simulator system can also include a cover removably mountable upon a top portion of the housing to enclose the housing. An access port or opening of an appropriate size and shape is formed in the cover.

While the support can have a variety of configurations, in one exemplary embodiment, the support can be a rail member disposed within the housing, such as on the base of the housing. The rail member can be an elongate, substantially rectangular member having a plurality of cut-outs formed in a portion of a bottom surface thereof. The rail member can also be disposed at a variety of locations on the housing, such as along a length dimension thereof. In certain exemplary embodiments, the support can include the rail member mountable upon a riser. One skilled in the art will appreciate that the riser can have a variety of configurations, such as a horizontally oriented plate member mounted upon a pair of support rails.

The strut member can also have a variety of configurations. In one exemplary embodiment, the bottom surface of each strut member can have a mating notch formed therein that is adapted to mate with the support. The mating notch can have a variety of sizes, such as a width sufficient to enable it to mate with the support in a clearance fit. The strut member can also include a specimen receiving opening formed therein. The specimen receiving opening of the strut member can have a width greater than the width of the mating notch.

One skilled in the art will appreciate that the sidewalls, endwalls, and cover can have a variety of configurations. Further, the access port formed in the cover can also vary in configuration depending upon the particular surgical procedure simulated. For example, in one exemplary embodiment, the access port can be a substantially oval shaped opening. The access port can also be a substantially rectangular shaped opening that occupies a majority of the surface area of the cover. Moreover, a perforable material can be provided to be placed over the cover to simulate skin and/or other tissue.

### BRIEF DESCRIPTION OF THE DRAWINGS

FIG. 1 is a perspective view of an exemplary embodiment of a simulator system;

FIG. 2 is a top perspective view of an exemplary embodiment of the base of the simulator system of FIG. 1;

FIG. 3 is a side elevation view of an exemplary embodiment of a rail of the simulator system of FIG. 1;

FIG. 4 is a front elevation view of an exemplary embodiment of a strut member of the simulator system shown in FIG. 1;

FIG. 5A is a side elevation view of an exemplary embodiment of a sidewall of the simulator system of FIG. 1;

FIG. 5B is a top plan view of the sidewall of FIG. 5A;

FIG. 6 is a bottom plan view of an exemplary embodiment of a cover for use with the simulator system of FIG. 1;

FIG. 7 is another embodiment of a simulator system;

FIG. 8A is a side perspective view of an exemplary embodiment of a posterior riser of the simulator system of FIG. 7;

FIG. 8B is a side elevation view of the posterior riser of FIG. 8A;

FIG. 8C is a front elevation view of the riser of FIG. 8A;

FIG. 9 is a bottom plan view of an exemplary embodiment of a cover for use with the simulator system of FIG. 7; and

FIG. 10 is an exemplary embodiment of a rigid arm for use with a minimally invasive system.

### DETAILED DESCRIPTION

Certain exemplary embodiments will now be described to provide an overall understanding of the principles of the structure, function, manufacture, and use of the devices and methods disclosed herein. One or more examples of these embodiments are illustrated in the accompanying drawings. Those skilled in the art will understand that the devices and methods specifically described herein and illustrated in the accompanying drawings are non-limiting exemplary embodiments and that the scope of the present invention is defined solely by the claims. The features illustrated or described in connection with one exemplary embodiment may be combined with the features of other embodiments. Such modifications and variations are intended to be included within the scope of the present invention.

Disclosed herein are devices to assist in simulating surgical procedures. In one exemplary embodiment, the device is a container or box-like object that serves as a representation of a body cavity, wherein a surgical specimen is able to be placed. While the box can have any configuration to represent a body cavity, an exemplary box is substantially rectangular and is formed of a variety of modular components, enabling to it be assembled, disassembled, cleaned, and transported with relative ease. At least one of the components of the system can be transparent to allow for multiple perspective views of the representative body cavity. However typically, substantially all of the components of the box are transparent.

One skilled in the art will appreciate that the exemplary simulator systems disclosed herein can be adapted to simulate spinal surgery procedures utilizing a variety of surgical approaches, including an anterior approach, a posterior approach, and a minimally invasive approach. Although the simulator system is described in the context of spinal surgery, one skilled in the art will appreciate that the simulator systems can be adapted to simulate a variety of other surgical procedures directed to other parts of the body. Thus, the surgical specimen or sample used herewith can be part of a vertebrae, a leg, an arm, etc. from a human or some other mammal.

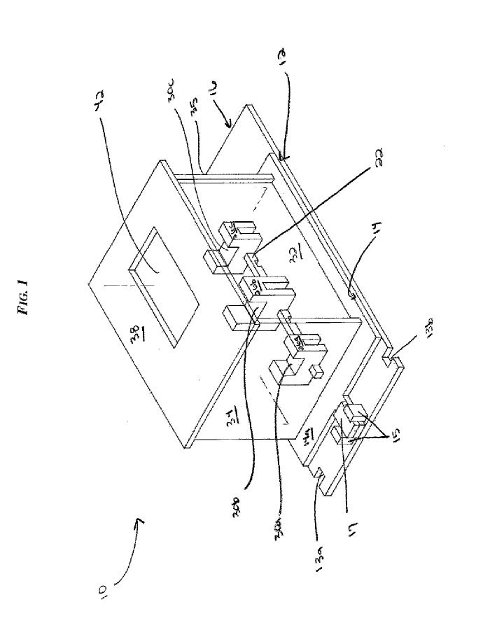

FIGS. 1-6 shown an exemplary embodiment of a simulator system 10 disclosed herein used to simulate a surgical procedure performed on a part of the spine using an anterior approach. As shown in FIG. 1, the simulator system 10 is generally in the form of a box having opposed sidewalls 32, 33 connected by endwalls 34, 35. The sidewalls and endwalls 32, 33, 34, 35 are adapted to mate with a base portion 12 having a plurality of strut members 26 disposed on a support member 22. The system 10 can also include a removably mounted cover or lid 38 having an opening 42 which allows access to a surgical specimen (not shown).

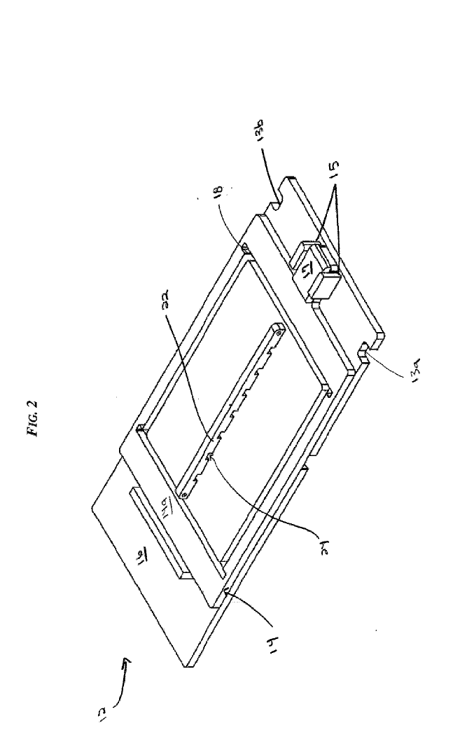

Referring now to FIG. 2, the base portion 12 of the system 10 can have any configuration that provides a foundation for the sidewalls and endwalls 32, 33, 34, 35 that form the box. The base portion 12 can be a single piece, or as shown, it is formed from two separate pieces that are removably mated together. One skilled in the art will appreciate that the two pieces of the base portion 12 can be mated to one another by a variety of mating techniques, such as pins, dowels, threads, a dovetail connection, an interference fit, a snap fit, a magnetic attachment, adhesives, etc. In an exemplary embodiment, the two pieces of the base portion 12 are mated together by dowels.

The bottom piece 16 of the base portion 12 can have any shape and size so as to form a platform upon which the box can be built. For example, the bottom piece 16 can be substantially circular, oblong, triangular, pentagonal, or rectangular. In an exemplary embodiment, the bottom piece 16 of the base portion 12 is substantially rectangular plate having at least one notch formed at an end thereof for mating with a stand (not shown), as will be discussed in more detail below. As shown, the bottom piece 16 has two notches 13a, 13b that are opposed to one another for receiving portions of a stand. While the exemplary mating technique is shown to utilize two notches 13a, 13b in the bottom piece 16 of the base portion 12, one skilled in the art will appreciate that any other technique can be used to mate the base portion 12 with the stand, including pins, a dowel, threads, a dovetail connection, an interference fit, a snap fit, a magnetic attachment, adhesives, etc. Moreover, the stand can mate with the upper piece 14 of base portion 12 or the entire base portion 12.

The bottom piece 16 can also include at least one mating feature to mate with the upper piece 14 of the base portion 12. While the mating features can be any of the features listed above, in the exemplary embodiment, the bottom piece 16 includes a notch 15 for mating with a flange 17 formed on the upper piece 16 of the base portion 12.

The bottom piece 16 can have any size that allows it to support the simulator system 10. For example, the bottom piece 16 of the base portion 12 can be the same size as the upper piece 14 of the base portion 12, or as shown, the bottom piece 16 has a size that is greater than that of the upper piece 14 of the base portion 12, and hence the rest of the simulator system 10, to provide a foundation upon which the rest of the system can be placed upon.

Still referring to FIG. 2, the upper piece 14 of the base portion 12 can have any shape that is desired for the bottom of the box. In an exemplary embodiment, the upper piece 14 can be similar in shape to the lower piece 16. That is, the upper piece 14 can be substantially circular, oblong, triangular, pentagonal, or rectangular, and shown, the upper piece 14 is a substantially rectangular plate having opposed top and bottom surfaces 14a, 14b. The upper piece 14 can also include at least one feature that is adapted to mate with the bottom piece 16 of the base plate 12. While the mating features can be any of the features listed above, in an exemplary embodiment, the mating features include at least one flange 17 that fits within the notch 15 of the bottom piece 16.

The upper piece 14 can have a variety of sizes depending upon the particular body cavity to be simulated. While the upper piece 14 of the base portion 12 can have the same size as the bottom piece 16, in an exemplary embodiment, the upper piece 14 of the base portion 12 has a size smaller than that of the bottom piece 16.

The top surface 14a of the upper piece 14 of the base member 12 has a plurality of features that allow the sidewalls and endwalls 32, 33, 34, 35 of the box to removably mate with the base portion 12. The mating features on the base portion 12 can be any mating element known in the art, such as pins, dowels, threads, a dovetail connection, an interference fit, a snap fit, a magnetic attachment, adhesives, etc. In an exemplary embodiment, the mating features are longitudinal grooves 18. One skilled in the art will appreciate that the groove 18 can have a variety of shapes, such as hemispherical, rectangular, triangular, trapezoidal, or oblong. As shown in FIG. 2B, an exemplary groove 18 is substantially rectangular, and it has a shape and dimensions sufficient to enable the sidewalls and endwalls 32, 33, 34, 35 to be received therein securely and to be held in position to form the box. For example, the groove 18 can have a depth in the range of about 0.375 inches, and a width in the range of about 0.75 inches. Moreover, the width of the groove 18 can be uniform, or it can decrease in the proximal or distal direction, depending upon the configuration of the sidewalls and endwalls 32, 33, 34, 35 (as will be discussed in more detail below). In an exemplary embodiment, the groove 18 has a substantially uniform width.

While FIG. 2 illustrates one set of mating features to allow the sidewalls and endwalls 32, 33, 34, 35 to removably mate to with the upper piece 14 of the base portion 12 to form the box, other exemplary embodiments include at least two sets of mating features. This is particularly advantageous in that it allows the user to adjust the size of the system 10 depending upon the particular type of surgery to be simulated.

Coupled to the top surface 14a of the upper piece 14 of the base portion 12 is a support 22 that assists in supporting a surgical specimen. The support 22 can be removably and replaceably secured or permanently adhered to the base portion 12 by such mating elements as pins, dowels, a dovetail connection, an interference fit, a snap fit, a magnetic attachment, adhesives, etc. In an exemplary embodiment, the support 22 is coupled to the upper piece 14 of the base portion 12 by adhesives. The support 22 can be adhered to the base portion 12 at a variety of locations, for example, the support can be centrally located along a length dimension thereof.

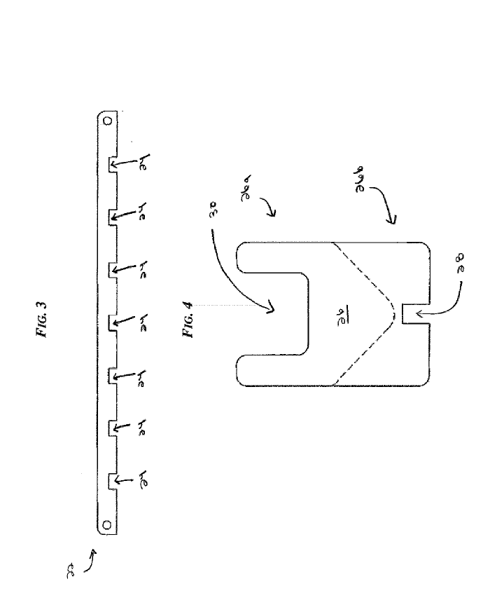

The support 22 can have any configuration that is suitable to engage and hold a strut member 26, which in turn holds a surgical specimen. As shown in FIG. 3, the support 22 can be a rail member, that is, an elongate, substantially rectangular member having a plurality of cut-outs 24 formed in a portion of a bottom surface thereof. One skilled in the art will appreciate that the cut-outs 24 can have any shape and size that allows them to receive a surgical specimen anchor, as will be discussed in more detail below. By way of non-limiting example, the cut-outs 24 can be substantially rectangular, having a length in the range of about 0.45 inch to 0.75 inch, and a height in the range of about 0.33 inch to 0.60 inch.

As noted above, strut members 26 are removably and replaceably matable to the support 22 to hold a surgical specimen. The strut member 26 can have any configuration that allows it to hold a surgical specimen, such as ovular, circular, triangular, rectangular, pentagonal, etc. As shown, the strut member 26 is substantially rectangular, having features 28 to mate with the support 22 at its bottom portion 26b and a specimen-receiving feature 30 at its top portion 26a. The support mating features 28 can be any mating feature known in the art, such as pins, threads, fasteners, a dovetail connection, an interference fit, a snap fit, a magnetic attachment, adhesives, etc. In an exemplary embodiment, the support mating feature 28 is a notch that corresponds in shape and size to the support 22 to provide a clearance fit and is secured by, for example, a fastener, such as a zip tie or a twist tie.

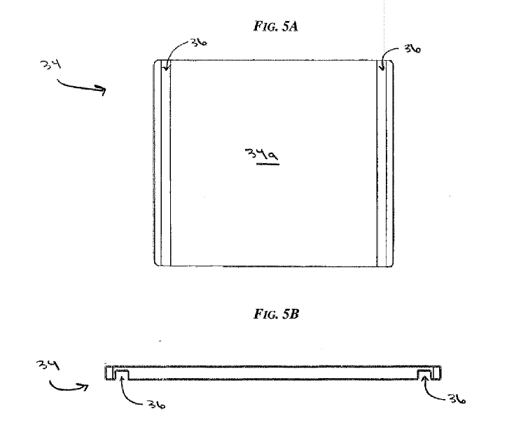

One skilled in the art will appreciate that the specimen receiving feature 30 can have any configuration that allows it to securely hold a surgical specimen within the feature 30 formed in the top portion 26a of the strut member 26. In the exemplary embodiment of FIG. 4, the specimen-receiving feature 30 is an opening having a substantially rectangular shape. The opening 30 can have a fixed size, or it can be adjustable, however it typically has a fixed size. The opening 30 can also vary in size depending upon the particular specimen used, but it should be sufficient to receive and hold the desired surgical specimen. For example, the opening 30 can have a depth of in the range of about 1.5 inches to 5 inches, and a width greater than the width of the mating notch 28. The width can be in the range of about 3 inches to 5 inches.

The size of the strut member 26 is generally determined so as to position the surgical specimen at a distance below the cover 38 that approximates the depth of the surgical site in an actually surgical procedure, and can be fixed or adjustable. By way of example, the strut member 26 has a fixed height that is in the range of about 2.5 inches to 5 inches, resulting in the strut member 26 being located at a distance in the range of about 2.5 inches to 4 inches below the cover 38. The simulator system 10 can also include strut members of varying sizes to allow the user to simulate various surgical procedures. In one exemplary embodiment, useful in spine surgery using an anterior approach, the simulator system 10 can include one strut member having a height in the range of about 4.5 inches to about 5 inches, another strut member having a height about 4 inches, and a third strut member having a height in the range of about 2.5 inches to 3 inches. This results in the respective strut members being located at a distance in the range of about 2.35 inches to 5 inches below the cover 38.

One skilled in the art will appreciate that the strut members 26 are modular. Further, while one strut member 26 can be used, it is more typical to use two or more cooperating strut members 26. As shown, the simulator system includes three strut members 26a, 26b, 26c having different sizes and specimen receiving features 30a, 30b, 30c of different dimensions.

Extending upward from the base portion 12 are opposed sidewalls 32, 33 connected by endwalls 34, 35. One skilled in the art will appreciate that the sidewalls 32, 33 and the endwalls 34, 35 can have a variety of shapes and sizes depending upon the body cavity simulated. In an exemplary embodiment, the sidewalls 32, 33 and endwalls 34, 35 are substantially rectangular plates having opposed inner and outer faces 32a, 32b, 33a, 33b, 34a, 34b, 35a, 35b. The rectangular plates that form the sidewalls 32, 33 have a length that is greater than the length of the plates that form the endwalls 34, 35, such that a box can be formed. The sidewalls 32, 33 and endwalls 34, 35 can also be configured to fit snugly and securely within the groove 18 of the base portion 12, and therefore have widths that are complementary to the width of the groove 18 formed in the base portion 12. Moreover, the height of the sidewalls 32, 33 and endwalls 34, 35 can be in the range of about 10 inches to 15 inches.

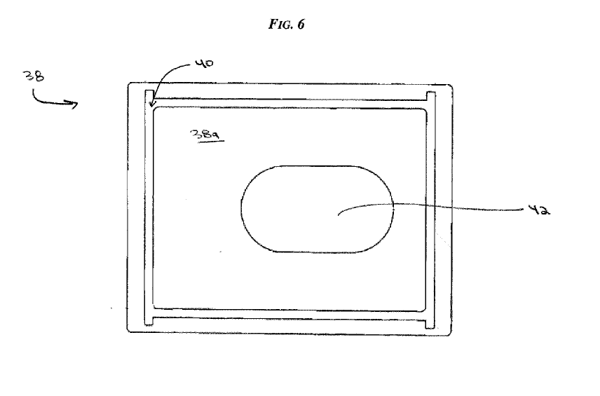

At least one of either the sidewalls or the endwalls 32, 33, 34, 35 can include features to mate with each other to facilitate formation of a box. By way of non-limiting example, FIGS. 5A-5B illustrate the endwalls 34, 35 having mating features that can receive the sidewalls 32, 33. In other embodiments the sidewalls 32, 33 can have mating features that can receive the endwalls 34, 35. One skilled in the art will appreciate that the mating features can be of any type suitable to allow the sidewalls and endwalls 32, 33, 34, 35 to be securely held together to form a box. For example, the mating features can be pins, threads, a dovetail connection, an interference fit, a snap fit, a magnetic attachment, adhesives, etc. As shown in FIGS. 5A-5B, the mating features are in the form of longitudinal grooves 36 that extend along the inner surface 34a, 35a of the endwalls 34, 35. While the groove 36 can have a variety of configurations, it should correspond in shape in size to the sidewalls 32, 33, so as to provide a snug and secure fit.

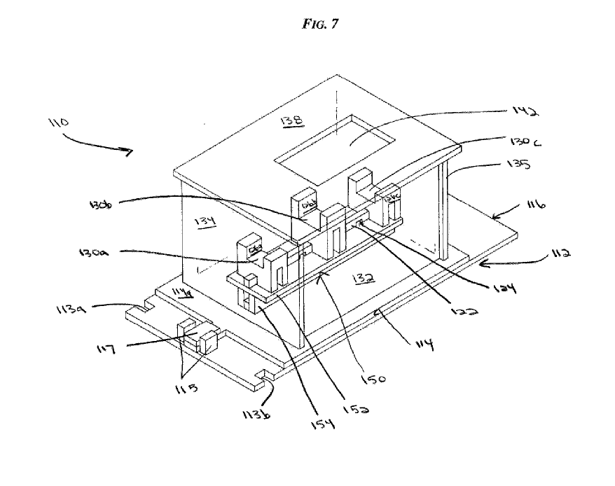

As noted above, a cover 38 or lid can be placed on top of the sidewalls and endwalls 32, 33, 34, 35 to complete the formation of the box. While the cover 38 can have a variety of shapes and sizes, in an exemplary embodiment shown in FIG. 6, the cover 38 has a shape that is complementary at least to the upper piece 14 of the base portion 12. That is, the cover 38 is substantially rectangular having opposed inner and outer surfaces 38a, 38b. The cover 38 can also have a variety of mating features to removably mate with sidewalls 32, 33 and endwalls 34, 35 to form the box. While the mating features can be any features known in the art, in an exemplary embodiment the mating feature is a groove 40 that extends along an inner surface 38a thereof. The groove 40 corresponds in shape and size to the sidewalls and endwalls 32, 33, 34, 35. That is, the groove 40 is substantially rectangular having a width is in the range of about 0.375 inches to 0.75 inches, and a depth in the range of about 0.33 inches to 0.66 inches.

The cover 38 can also have an access port 42 or opening that extends through the inner and outer surfaces 38a, 38b. One skilled in the art will appreciate that the access port 42 can have a variety of shapes and sizes depending upon the type of surgical procedure to be simulated. By way of non-limiting example, as illustrated in FIG. 6, the cover 38 can have an access port 42 having a substantially oval-shaped opening. While the opening 42 can have a variety of sizes, in an exemplary embodiment the opening 42 should be of a size that approximates the dimensions of a retracted incision during a surgical procedure of the type to be simulated. For example, the opening 42 occupies about one-third of a surface are of the cover 38, thus making it suitable to simulate a spinal surgery using an anterior approach. In other exemplary embodiments, the cover 38 can be configured for posterior approaches or minimally invasive surgery, as will be discussed in more detail below.

The outer surface 38a of the cover 38 can include a fastener (not shown) that extends long at least a portion of the edges thereof. The fastener can be any adhesive or hook and loop fastener that allows a material to be attached to the cover 38 to simulate the skin surface. By way of non-limiting example, the fastener is a hook and loop fastener that is about 1 inch in diameter. One skilled in the art will appreciate that the material can be any perforable material that is able to simulate the skin surface, such as fabric, leather, rubber, a polymer, or any combination of these materials. In an exemplary embodiment, the material has a fabric underlayer and a rubber top layer, which, in combination with the access port 42, provides a more accurate anatomical model.

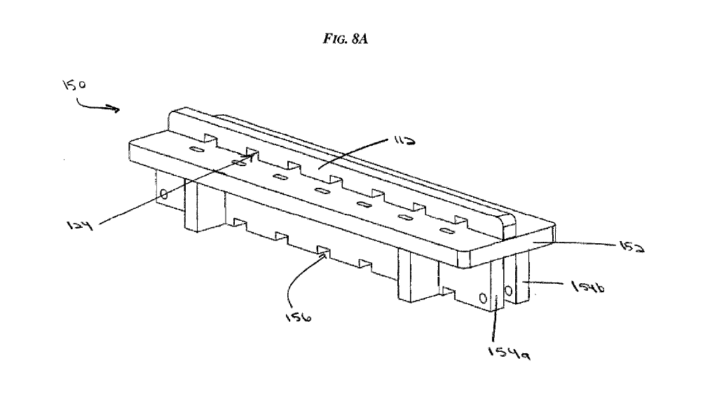

The apparatus can also be configured to simulate surgeries using other approach techniques, including a posterior approach and minimally invasive techniques. FIGS. 7-9 illustrate an exemplary embodiment of a simulator system 100 configured to simulate spinal surgeries using a posterior approach. The exemplary system 100 is similar to the system 10 discussed above with respect to the anterior approach and includes a support 122 having cut-outs 124 formed in bottom portion thereof for receiving a surgical specimen anchor. However, the strut member(s) 126 and cover 138 are adapted to provide a more accurate simulation of a posterior approach to the spine by raising the position of the surgical specimen (e.g., a spine or portion thereof) to a position that is closer to the cover 138.

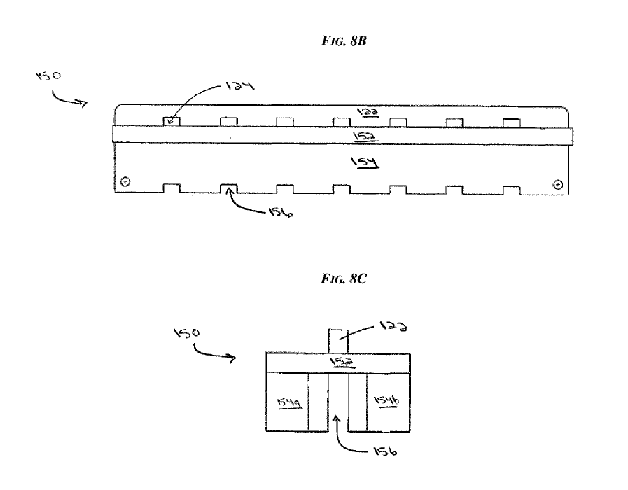

The surgical specimen is raised, or its height is adjusted, by elevating the position of the strut member 126. While the height of the strut member 126 can be adjusted by any device known in the art, an exemplary embodiment shown in FIGS. 8A-8C, raises the height of the strut member 126 using a riser 150 that is removably mated to the support 122. The riser 150 can have any configuration that allows the support 122 to mount thereto. As shown, the riser 150 includes a horizontally-oriented plate member 152 that is mounted on at least one support rail 154. Any number of support rails 154 can be used to support the plate member 152, however the embodiment shown in FIG. 8B uses two support rails 154a, 154b. One skilled in the art will appreciate that any known mating technique can be used to mate the plate member 152 and the support rails 154a, 154b. Suitable mating techniques envision the use of pins, a dowel, threads, a dovetail connection, an interference fit, a snap fit, a magnetic attachment, adhesives, etc. However in the exemplary embodiment, the plate 152 and the support rails 154a, 154b are mated by pins.

One skilled in the art will appreciate that the support rails 154a, 142b can have any configuration that can support the plate 152, as well as the support 122 and the strut(s) 126 that are mounted thereto. In an exemplary embodiment, the support rails 154a, 154b are similar to support 22 discussed with respect to FIG. 3. That is, the support rails 154a, 154b are substantially rectangular members having a plurality of cut-outs 156 formed in a portion of a bottom surface thereof to receive a surgical specimen anchor. This is particularly advantageous in that it allows a user the option of anchoring the surgical specimen to the support rails 154a, 154b, the support 122, or both. As a result of the riser 150, the respective strut members 126a, 126b, 126c can be located at a distance in the range of about 3.5 inches to 10 inches below the cover 38.

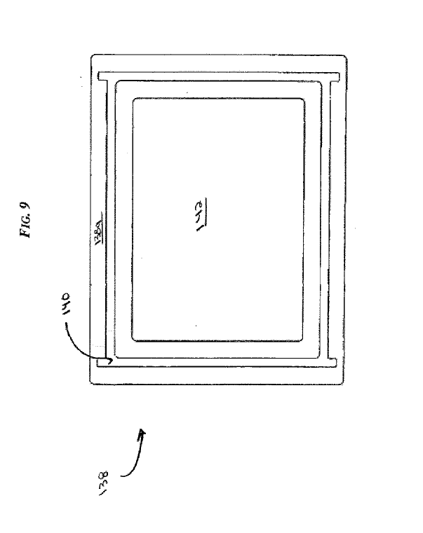

The cover 138 is similar to the cover 38 discussed in FIG. 6, and it can likewise include a layer of material placed thereover which is intended to mimic skin and other tissue. The posterior access configurations, however may use a cover 138 that has an access port 142 that is substantially rectangular as shown in FIG. 9. In an exemplary embodiment, the access port 142 occupies almost the entire surface area of the cover member 138. This shape and size of the access port 142 is covered with a simulated skin surface. This simulated skin surface allows the user to simulate approach techniques (including retraction) as well as facilitates the use of a MIS portal.

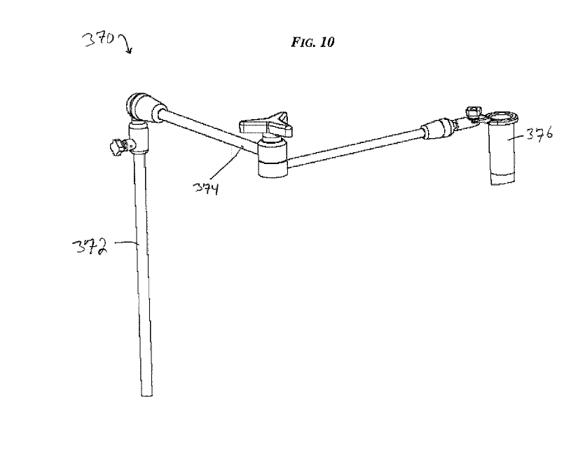

One skilled in the art will appreciate that the simulated system 10, 100 can also be used in simulations of techniques that involve minimally invasive surgery (MIS). For example, system 100, typically useful for a posterior approach, can be modified to simulate MIS techniques. Suitable modifications include the use of a rigid arm attachment system, such as rigid arm attachment system 370 shown in FIG. 10. The rigid arm attachment system 370, shown in FIG. 10, includes a vertical component 372 and an adjustable horizontal component 374. With an appropriate attachment block the rigid arm system 370 may be fixed to the sidewall, or to any other appropriate support surface. One skilled in the art will appreciate that the rigid arm, and particularly the distal end of the horizontal component 374, is used to support an access port 376, which will be placed in the cover, through the incision in the skin-like fabric and the opening in the cover. The access port, as is known in the art, is a portal through which surgical instrumentation is passed to access the body cavity, or in this case, the simulated body cavity.

In use, a portion of the simulator system 10, 100, and in particular the bottom piece 16, 116 of the base portion 12, 112, can be placed on the edge of a table or some other surface. The remaining portion of the simulator system 10, 100 can extend beyond the edge of the table and can be supported by a stand (not shown). One skilled in the art will appreciate that the stand has any configuration that can support at least two-thirds of the weight of the system 10, 100. In the exemplary embodiment, the stand can include two legs that are mated to the base portion 12, 112 of the system 10, 100. This configuration allows the system 10, 100 to be used in conjunction with an imaging device, such as a C-arm, more closely simulating actual surgical conditions, especially spinal surgery.

Once the simulator system 10, 100 is assembled and properly configured for the desired surgical simulation, a surgical specimen (e.g., a portion of a spine, such as an animal spine) can be placed in the openings 30, 130 of the strut member 26, 126 and secured by a surgical specimen anchor (e.g., a tie). One skilled in the art will appreciate that the surgical specimen can be secured to the strut member 26, 126 in any way that will not damage the specimen, yet maintain its place within the opening 30, 130. In exemplary embodiment, the specimen is secured by a twist or zip tie that loops around the specimen and fits within the cut-outs 24, 124 of the support 22, 122 and/or support rails 154a, 154b.

One skilled in the art will appreciate further features and advantages of the invention based on the above-described embodiments. Accordingly, the invention is not to be limited by what has been particularly shown and described, except as indicated by the appended claims. All publications and references cited herein are expressly incorporated herein by reference in their entirety.

What is claimed is:

1. A surgical simulator system, comprising:
a housing having a base and sidewalls;
a plurality of strut members adapted to be removably disposed on a support and spaced apart from each other, each strut member having a bottom surface matable with the support and a top surface having a specimen receiving opening formed therein; and
a cover removably mountable upon a top portion of the housing to enclose the housing, the cover having an access port formed therein.

2. The system of claim 1, wherein the support is a rail member disposed within the housing, on the base of the housing, the rail member being oriented along a length dimension of the housing.

3. The system of claim 2, wherein the support includes the rail member mounted upon a riser.

4. The system of claim 1, further comprising a perforable material adapted to be placed over the cover.

5. The system of claim 2, wherein the rail member is an elongate, substantially rectangular member.

6. The system of claim 5, wherein the rail member has a plurality of cut-outs formed in a portion of a bottom surface thereof.

7. The system of claim 1, wherein the bottom surface of each strut member has a mating notch formed therein that is adapted to mate with the support.

8. The system of claim 7, wherein the mating notch has a width sufficient to enable it to mate with the support in a clearance fit.

9. The system of claim 8, wherein the specimen receiving opening of the strut member has a width greater than the width of the mating notch.

10. The system of claim 9, wherein the width of the specimen receiving opening is in the range of approximately 3 to 5 inches and a depth of the specimen receiving opening is in the range of approximately 1.5 to 5 inches.

11. The system of claim 1, wherein the access port formed in the cover is a substantially oval shaped opening.

12. The system of claim 1, wherein the access port formed in the cover is a substantially rectangular shaped opening.

13. The system of claim 12, wherein the rectangular opening occupies a majority of the surface area of the cover.

14. The system of claim 3, wherein the riser comprises a horizontally oriented plate member mounted upon a pair of support rails, with the rail member mounted on a top surface of the plate member.

15. The system of claim 14, wherein the bottom surface of each strut member has a mating opening formed therein that is adapted to mate with the support.

16. The system of claim 1, wherein the surgical simulator system is adapted to simulate spine surgery and the specimen receiving notch is adapted to receive a portion of a spinal column.

17. The system of claim 11, wherein the system is adapted to simulate an anterior approach for a surgical procedure on a spine.

18. The system of claim 12, wherein the system is adapted to simulate a posterior approach for a surgical procedure on a spine.

19. The system of claim 4, wherein the system is adapted to simulate a minimally invasive surgical procedure on a spine.

20. The system of claim 1, wherein at least one of the housing and strut members and cover are modular.

21. The system of claim 1, wherein at least one of the housing and strut members and cover are transparent.
